(19) United States
(12) Patent Application Publication
(10) Pub. No.: US 2002/0055976 A1
(43) Pub. Date: May 9, 2002

(54) Method and system for transferring A/V messages through computer network

(76) Inventor: Kwang Kyun Chung, Seoul (KR)

Correspondence Address: Richard E. Fichter, BACON & THOMAS, PLLC, Fourth Floor, 625 Slaters Lane, Alexandria, VA, 22314-1176, US

(21) Appl. No.: 10/014,595

(22) Filed: Dec. 14, 2001

Related U.S. Application Data
(63) Continuation of application No. PCT/KR00/00148, filed on Feb. 24, 2000.

(30) Foreign Application Priority Data
Jun. 15, 1999 (KR) 1999-22287

(51) Int. Cl. G06F 15/16

(52) U.S. Cl. 709/206; 709/231; 700/94

(57) ABSTRACT

The present invention provides a method and system for sending and receiving audio-visual messages through a computer communication network(s) , wherein the audio-visual information comprising visual information such as personal data of the sender and the recipient, holographs, pictures, etc. and audio information such as voice of the sender, music, songs, etc. may be sent and received through the computer communication networks, i.e. the Internet. The system for the present invention comprises one or more computers or input devices with the functions of data processing for inputting the composite messages; a computer communication network such as the Internet, etc.; a computer as an output device for receiving the composite message from the composite message input devices through the computer communication network and then storing and printing it; a message card that is connected to the output device for printing the visual information and storing the audio information. The method for the present invention comprises the steps of: inputting the composite message, transmitting the composite message through the computer communication network, receiving the composite message from the computer communication network and storing it, reproducing the composite message, and reading and listening of the composite message.

This application is a Continuation Application of PCT International Application No. PCT/KR00/00148 filed on Feb. 24, 2000, which designated the United States.

### FIELD OF THE INVENTION

The present invention relates to a method and system for sending and receiving audio-visual messages by using a computer communication network(s), and particularly, to a method and apparatus(system) for sending and receiving messages (hereafter referred to as composite messages) comprising audio information that includes audio messages, music, etc. as well as visual information including characters, images(photos, pictures, holographs), etc. by using computers or the like(including cellular phones, digital TVs, PDAs and/or devices with functions of data processing) and a computer communication network(s) such as the Internet, PC communication networks, or the like.

### BACKGROUND OF THE INVENTION

Recently, in addition to telephone order and home shopping, electronic commerce using the Internet is becoming popular as a means to purchasing goods at home. Though the purchased goods are usually delivered to the purchaser, there are also cases where the seller is asked by the purchaser to deliver the goods to a third party together with a letter of explanation from the purchaser. In the meantime, if the seller could express his gratitude to the client by means of a voice message, rather than just a brief note or letter, the seller would be given more credence and remembered for his or her special attention and the high quality of services. Also, if a present could be delivered with a composite message comprising voice message of the purchaser, the impression left on the person receiving the present would be far greater and thus the value of the present would become far more its mere price.

Further, the audio-visual message will be very useful for simple greetings, guidance, advertisement, and so on.

The following three are known in the art for sending such a composite message:

1) A card recorded with specific voice(s)

2) A card for recording voice(s) therein

3) A method and system for sending a voice card by the so-called automatic response system of the telephone

FIG. 1 represents a block diagram of a voice card recorded with a specific voice(s). The card comprises a ROM 10 stored with a specific voice(s), a voice decoder 11, a D/A converter 12, a controller 13 and a speaker 14. The card's disadvantages are that the process for recording the user's voice is inconvenient and that production thereof is possible only upon a bulk order.

FIG. 2 shows the structure of a voice card capable of recording the voice of the user. The card includes an input part 20 which comprises a microphone for inputting a voice(s,) an A/D converter 21 which converts the inputted analog audio signals into digital signals, a voice encoder 22 for compressing and storing the digital signals, a voice signal memory 23 for storing the digitally coded audio signals, a decoder 24 for decoding the digitally coded audio signals, a D/A converter 25 for converting the digital signals into analog signals, a controller 26 and a speaker 27.

The voice card as shown in FIG. 2 is easy to use but very expensive. Further, a separate delivery means or system is necessary and this will require a long time for the card to be sent to a remote place.

FIG. 3 shows a block diagram of the system for sending a voice card by using the automatic response system of public telephone exchanges according to the Korean Patent Application laid-open No. 99-23086. The system comprises a first means having an input part 30 which receives the voice inputted through a telephone line, an A/D converter 31 which converts the inputted analog audio signals into digital signals, a voice encoder 32 for encoding and storing the digital signals, and a first controller 33 for controlling the operations of the input part 30, the A/D converter 31 and the voice encoder 32; and a second means having an audio signal memory 34, a decoder 35 for decoding the audio signals, a D/A converter 36 for converting the digital signals into analog signals, a second controller 37 for controlling the operations of the voice signal memory 34, the decoder 35 and the D/A converter 36, and a speaker 38. The above Patent Application discloses also a method for sending a voice card by using the ARS system which comprises the steps of recording an audio message, storing the recorded audio message onto an independent card, delivering the card and reproducing the audio information stored in the card.

The system shown in FIG. 3 has the following disadvantages:

First, the cost for constructing the system is very expensive since telephone interfaces must be installed for using the automatic response system.

Secondly, information such as addresses of the sender and the recipient have to be inputted though a telephone or sent to the service provider by fax, and the service provider would have to confirm if the acquired information is in order.

Thirdly, in many cases, the quality of the audio signals would not be so good, since the voice data are transmitted in the form of analog signals through a telephone line.

Fourthly, images, such as letters, holographs or pictures cannot be delivered.

### SUMMARY OF THE INVENTION

The present invention, designed to resolve the disadvantages of the prior arts as described above, has an object to provide a method and system for sending and receiving quickly, accurately and cost effectively composite messages comprising visual information such as characters, diagrams or the like and audio information such as voice message, music or the like to the other party.

To achieve the above object and others, the present invention provides a method and system for sending and receiving composite messages through a computer communication network. The method according to the present invention may comprise the steps of: inputting and storing visual and audio information to/at a computer (or the like) as an input system, the visual information being such as the name and address of a user or a sender and the other party, the audio information being such as voice of the sender, music, etc.; transmitting the stored visual and audio information through a computer communication network and storing it at a computer as an output system; outputting the stored information signal and storing or printing the audio information and the visual information onto a composite message card; sending the processed message card to a recipient; and reproducing the audio information from the delivered message card for the recipient's listening thereto. The system comprises such inputting and outputting apparatus, communication/network(s) and message cards as described for the above method.

Moreover, the present invention may be further explained in detail as the method comprising the steps of: inputting the composite message to the input system; transmitting and storing the composite message from the input system to/at a server computer through the computer communication networks by using a mail box of a PC communication network or a website of the Internet, etc.; receiving the composite message stored at the server computer by downloading and storing it through the output system; and storing and printing the composite message retrieved from the output system onto the message card.

According to the present invention, both visual and audio information are printed or recorded on the message card through the computer communication network by the service provider and the message card with printed and recorded information is sent to the recipient quickly and accurately, the visual information being inputted through the keyboard of a computer or a digital camera or a scanner or the like by the sender, while the audio information being inputted through a sound editing equipment or a sound card or the like of a computer.

### BRIEF DESCRIPTION OF THE DRAWINGS

The above and other objects, features and advantages of the present invention will become apparent from the following description of the preferred embodiments or examples taken with reference to the accompanying drawings, in which:

FIG. 1 is a block diagram showing the structure and operation of a card recorded with specific voice(s);

FIG. 2 shows the structure and operation of a card for recording voice(s) therein;

FIG. 3 shows a block diagram of a method and system for sending a voice card by using the ARS system of the telephone lines;

FIG. 4 illustrates a block diagram of the system for sending and receiving a composite message according to a first preferred embodiment of the present invention;

FIG. 5 provides a block diagram of the system for sending and receiving a composite message according to a second preferred embodiment of the invention;

FIG. 6 presents a block diagram of a modification of the system in FIG. 5;

FIG. 7 shows a flowchart for the process of inputting and transmitting a composite message according to the present invention; and

FIG. 8 presents a flowchart showing a process through which a composite message information is downloaded from a server computer.

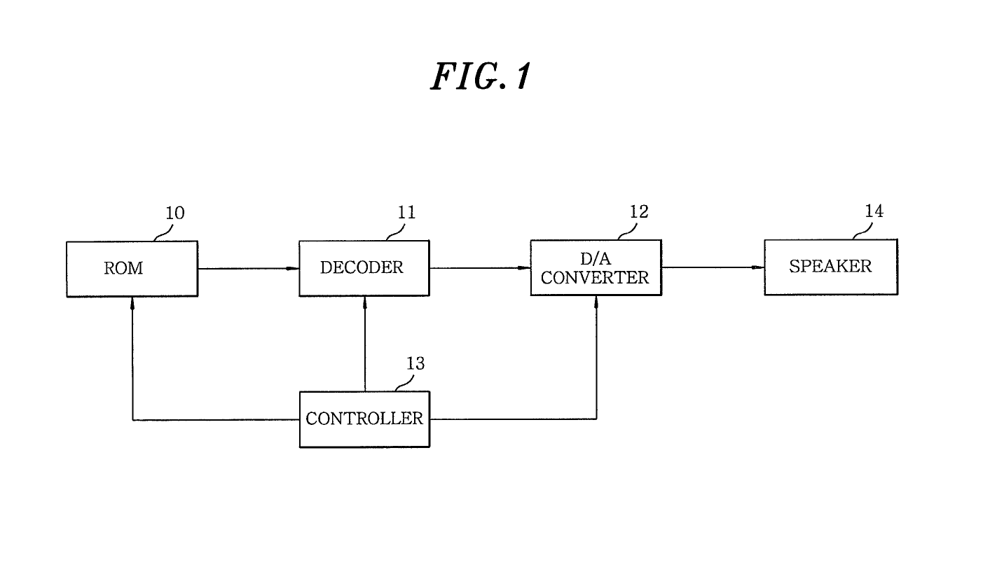

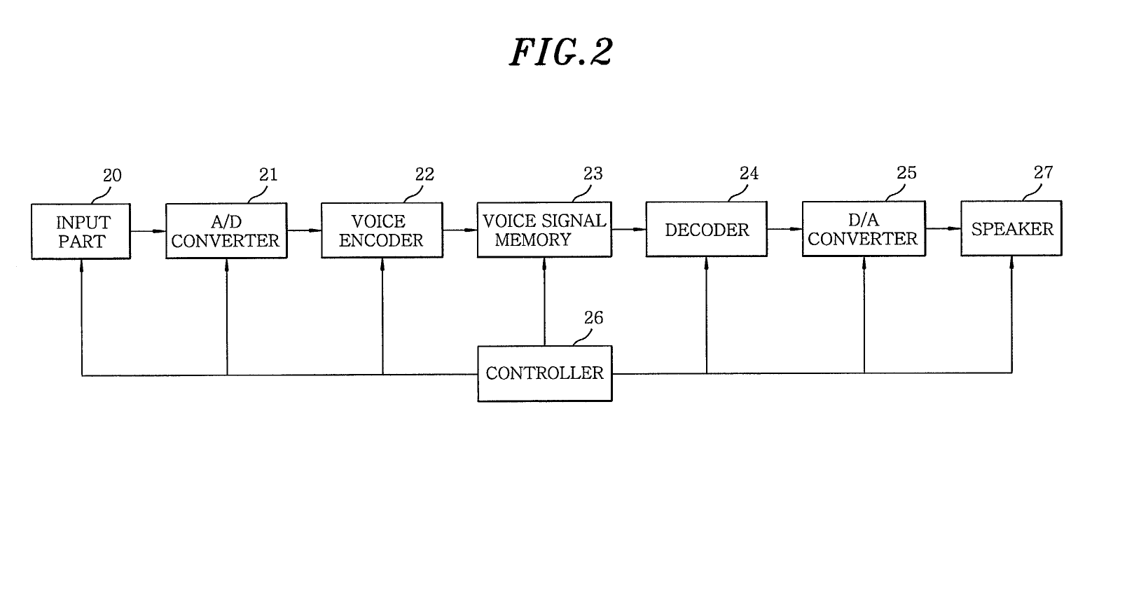

### DETAILED DESCRIPTION OF THE PREFERRED EMBODIMENTS

The present invention will now be described in detail by way of examples and preferred embodiments.

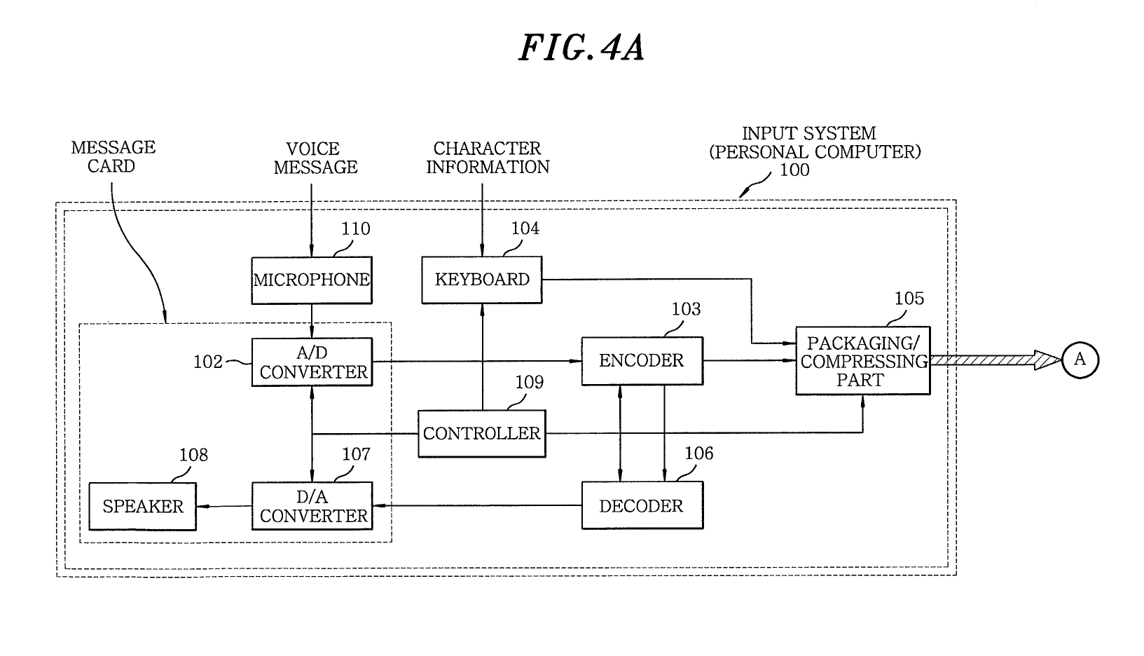

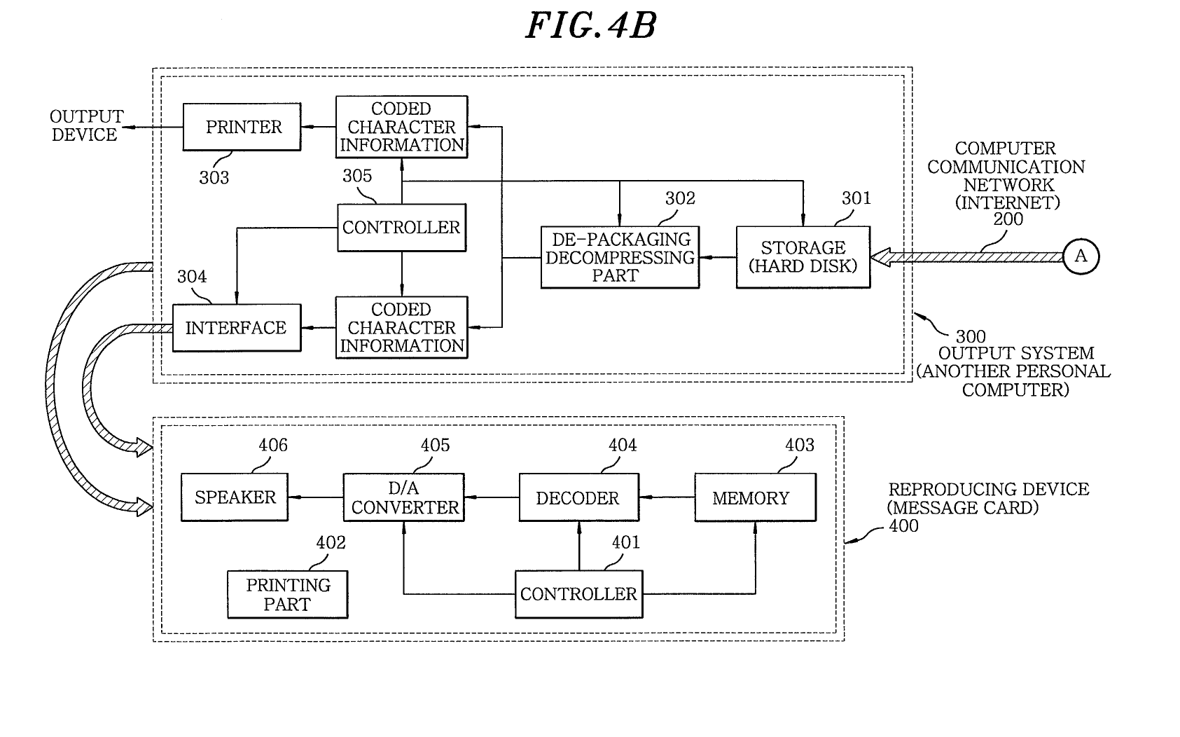

FIG. 4 shows a block diagram of a system for sending and receiving an audio-visual message by using a computer communication network according to a first embodiment of the present invention. The system is composed of a personal computer(PC) as an input device 100 of a composite message(s); a computer communication network 200, or the Internet, connected to the input system 100 for transmitting the composite message; an output device 300 as a computer connected to the computer communication network 200 for receiving and storing the composite message; and at least one message card 400 as a receiving unit for storing and reproducing the composite message received from the output system 300.

The respective input device 100 includes, for example, a microphone 101 for inputting the audio information, an A/D converter 102 for converting the audio information received through the microphone 101 into digital signals, an encoder 103 for encoding the digital audio information signals converted by the A/D converter, a keyboard 104 for inputting the literal information such as the names and addresses of the user and the other party(a sender or recipient), a letter, and so on, a packaging/compressing part 105 for combining and compressing the encoded digital audio and literal information signals, a decoder 106 for verifying the encoded audio information signals, a D/A converter 107, a speaker 108, and a controller 109 for controlling operation of the above parts. The above described input device may be owned or rented by the user, and ordinary PCs equipped with the above-mentioned parts are available in the market.

A computer program or software for use in the input system may be provided by the service provider(hereinafter, referred to as the Provider) of the system of the present invention through the computer communication network either with or without charge.

The output device 300, provided to store composite messages received through the computer communication network 200 from the input device 100 and output the stored messages to be recorded in or printed onto the message card, may comprise a hard disk 301 as a memory for the composite message signal data, a de-packaging/decompressing part 302 for decompressing the compressed composite message signal data and separating the packaged data, a printer 303 for printing out the literal information such as the names and addresses, the letter and so on, decoded from the de-packaging/decompressing part 302, an interface 304 for outputting the encoded audio information from the de-packaging/decompressing part 302, and a controller 305 for controlling the operation of the above-mentioned parts. Such an output device, readily available in the market as ordinary PCs, is operated by the Provider.

The message card 400 is activated by the Provider with the output device 300, the operation of which is controlled by the controller 401 to reproduce and print the encoded visual information on the printing part 402 by the printer 303 and to store the encoded audio information in the memory 403 by means of the interface 304.

To complete the Provider's service, the message card 400, processed as described above, is delivered to the recipient by the Provider or a third party(a person authorized by the Provider, a delivery service, etc.) and it may be accompanied by or incorporated with a letter, toy or other goods.

When the recipient sees the name and address of the sender and other literal information on the printing part 402 of the message card 400 and operates the card, the reproduction of the audio information signal will be controlled by the controller 401, thereby the encoded audio signal data in the memory 403 is converted by the decoder 404 into digital signals, which are then converted into analog signals by the D/A converter 405 to be heard as the audio information through the speaker 406. Through this process, the visual and audio information sent by the sender is delivered perfectly to the recipient in the form of a multimedia card.

In case the service area of the Provider is large or a large number of persons, i.e. goods or card delivery service agents, are authorized to deliver the message cards, the Provider may choose not to process the message cards directly for delivery. That is, the composite message information may be transmitted to and stored at the computer terminals of those agents, for example, for exclusive processing of the messages or the message information may be downloaded to and stored at those terminals by the agents, through the computer communication network. Thus, the message information may be stored or printed on the card to be delivered by the agents to the addressee.

A first embodiment of the method for sending and receiving the composite message through a computer communication network according to the present invention comprises the steps of:

Inputting the literal information such as the personal data of the sender and the recipient, e.g., addresses, names, etc. and where necessary, greetings, notices and so on, by using the keyboard of the computer as the input device 100 and also the audio information to the computer by using a sound card, a microphone, etc., these inputted visual and audio information being converted to digital signals according to the function of the computer for being packaged and compressed, and stored at the computer;

Making the input device 100 access the computer communication network such as the Internet to reach the server computer of the Provider and thus the visual and audio information signals are transmitted to and received at the server computer and stored therein;

Having the visual(image) and audio information signals from the server computer received and downloaded onto the computer 300 of the Provider as the output device for being stored therein;

Activating a message card 400 with the computer 300 as the output device so that the literal information stored in the memory may be reproduced and printed on the printing part of the card, while the audio information may be recorded at the card; and

Delivering the processed message card to the recipient or addressee.

The recipient will see the visual information such as the personal data, greetings, notices, etc. on the printing part of the card and operate the message card. The audio information signals stored in the message card is decoded and D/A converted to be reproduced as the audio information through the speaker so that the recipient may hear the reproduced information.

Though, in the above described embodiment, the visual information is described as characters inputted through the keyboard of the computer, a variety of graphic information such as drawings, holographs, figures, etc. may be, of course, in addition to characters, transmitted and reproduced by using a scanner or the like.

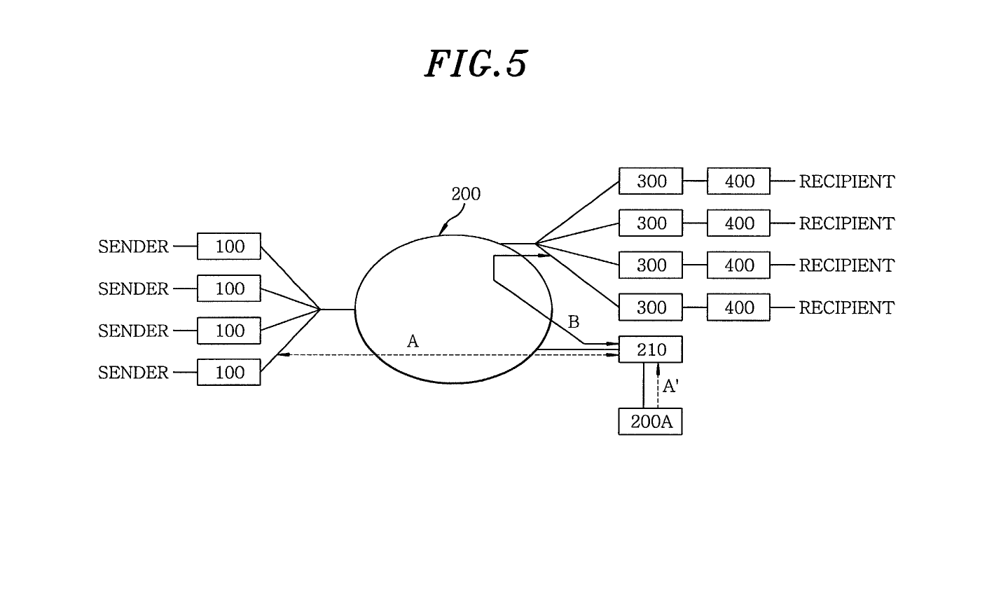

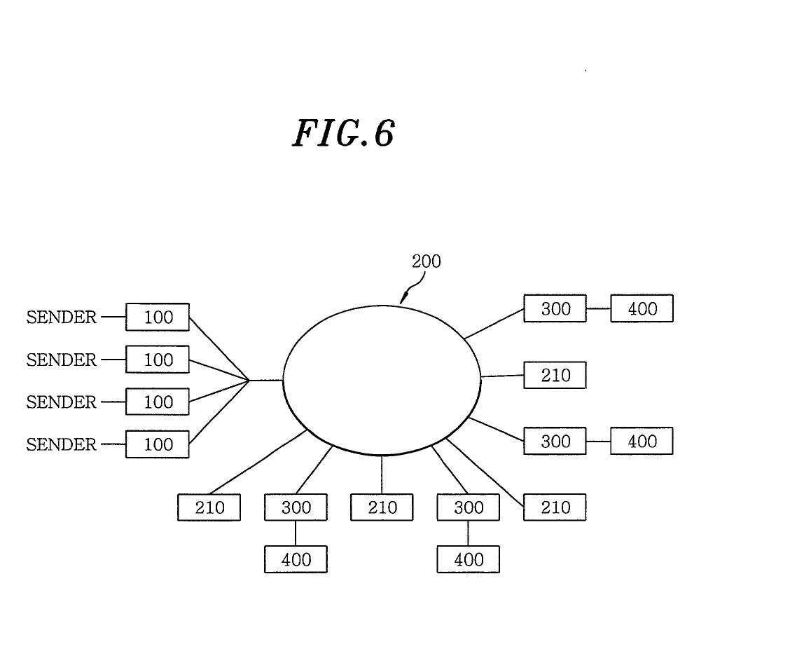

FIGS. 5 and 6 are block diagrams showing the system for sending and receiving the composite message by using the computer communication network according to a second embodiment of the invention. The system according to this embodiment comprises one or more composite message input devices 100 as a personal computer(PC), owned by each sender; a server computer 210 connected to a website of the Provider of the composite message transmission/delivery service on the Internet 200 as the computer communication network for transmitting the composite message, which may be accessed by the input devices 100; one or more output devices 300 as a computer which may access the server computer 210 through the Internet; a telephone network 200A with an access to an automatic response system of the above server computer 210; and one or more message cards 400 as a message receiving means for storing and reproducing the composite message through operation of the output devices 300.

The input devices 100, the computer communication network 200, the output devices 300 and the message cards 400 will not be further described in detail, as they have the same constructions and functions as described in the embodiment 1.

The second embodiment includes a detailed explanation of the method and system of the first embodiment, in which the sender and the Provider were merely described as being connected through the computer communication network and transmitting composite messages to the output device 300 in order to make use of the composite message delivery service. That is, the method and system of this embodiment clarifies that the respective sender may access the server computer 210 connected to a website(s) established on the Internet 200 by the Provider for sending and storing the composite message and the Provider may receive the composite messages or have them downloaded from the server computer 210 by and to the output devices 300.

In other words, in this embodiment, a sender may transmit and store the composite message to/at the server computer combined to a website established by the Provider and then, the Provider may retrieve the composite message or have the message downloaded through an output device for providing the composite message delivery service.

That is to say, a sender may access the server computer 210 on the Internet 200 through his or her own PC, the composite message input device 100 for transmitting and storing the composite message information comprising visual(image) and audio information(refer to A and A′ of FIG. 5); the Provider may have the information downloaded from the server computer 210 through one of the output devices 300 so that the information may be retrieved and stored therein(refer to B of FIG. 5); thereafter, the system of the invention operates in the same way as in the first embodiment and the message card 400 containing the composite message or the goods accompanying or incorporated with the message card 400 may be delivered to the recipient.

Further, the present embodiment is different from the first embodiment in the fact that all or part of the audio information may be transmitted through a telephone network 200A.

In case where the sender can not use an input system 100 for sending all or part of the composite message information, the composite message information other than all or part of the audio information may be transmitted and stored at the server computer 210 by either the sender directly or a third party. The audio information such as voice of the sender, etc. may be transmitted and stored at the server computer 210 through the telephone network 200A by using the automatic response system of the server computer 210. Then, the system of the invention operates in the same manner as in the first embodiment and the message cards 400 with the composite message or the goods accompanying or incorporated with the card 400 may be delivered to the recipient.

Though it was described above as only one website being set up, for example, and independent website for each different country or region can be established(refer to FIG. 6) and several output devices may respectively access the server computer of each website through the Internet so as to receive the composite message information or have it downloaded.

Further, though it was described above that sending and receiving the audio information through the telephone network was carried out in order to fill up the other part of the composite message information, it is also possible to have the audio information transmitted and stored first through the telephone network and then the remaining information among the composite message information by the input device.

The flow of the processes in the method and system according to the present invention will now be described.

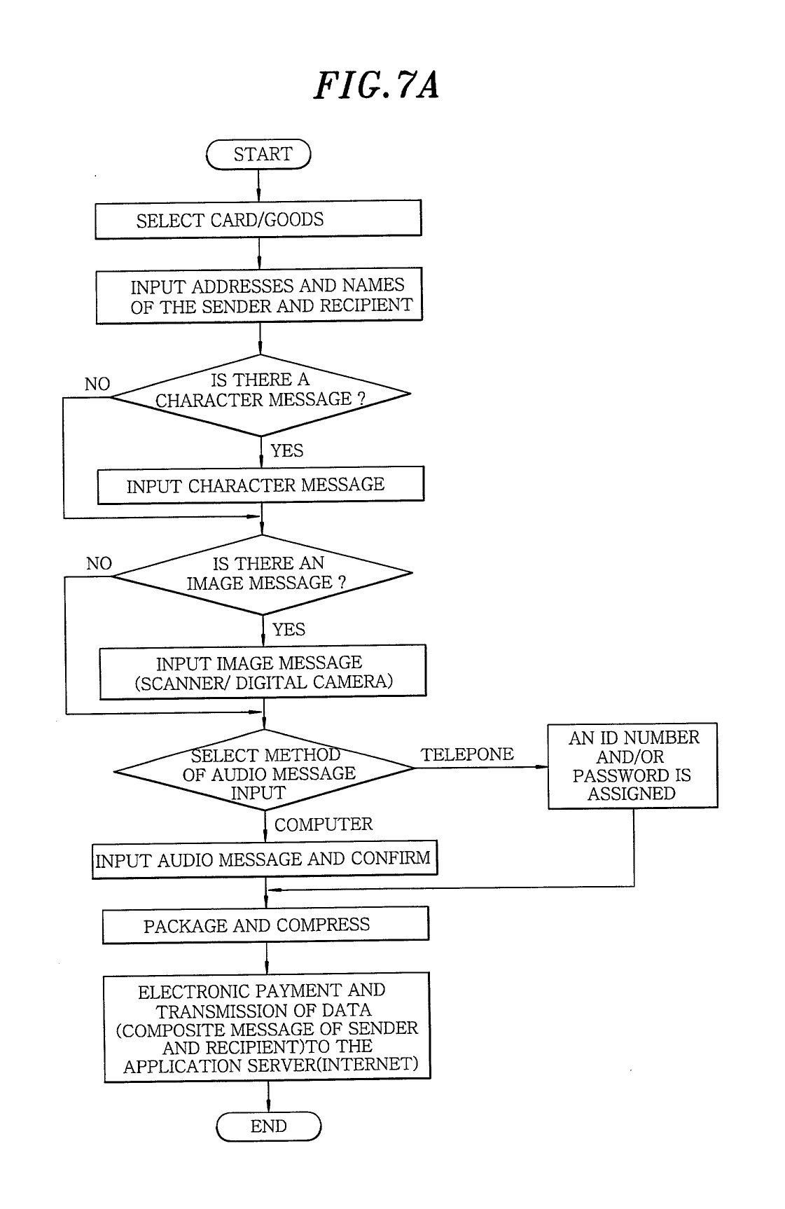

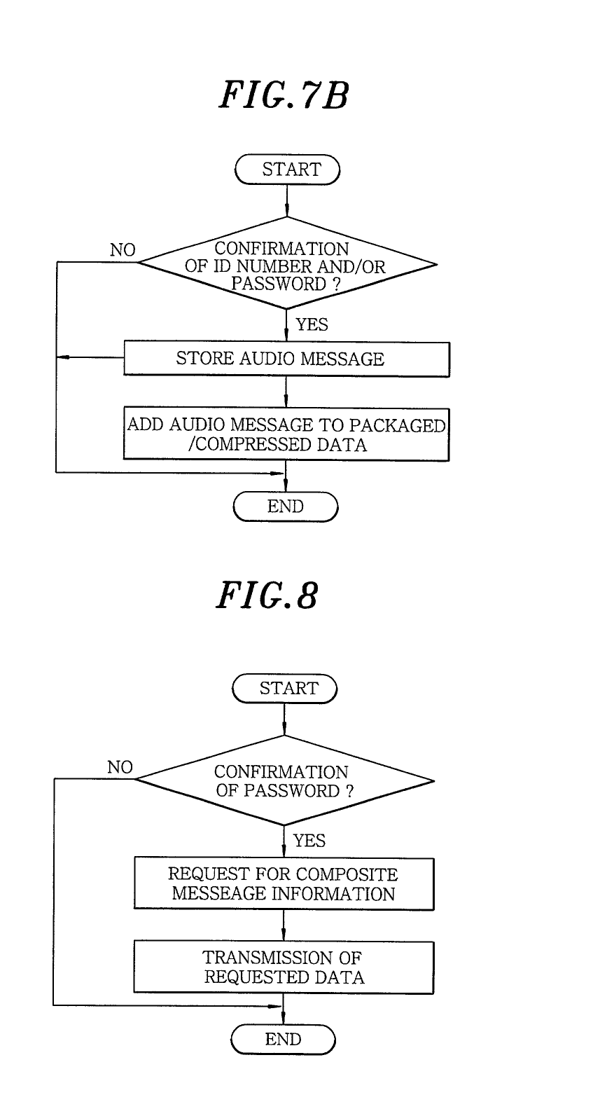

FIG. 7 is a flowchart showing the process of inputting and sending the composite message according to the present invention.

In FIG. 7, the sender may connect the input device to the server computer of the Provider through the Internet and thus the server computer will be initialized and make its instructions for selecting a message card alone or goods incorporated therewith shown to the sender. Then, the sender will select a relevant card or goods and input addresses and names of the sender and the recipient and possibly a character message. A literal message may be inputted, if so required.

Subsequently, either an image message may be inputted, if required so, or the process will move to the next step. The audio message may be inputted by means of a computer or through a telephone system. For the latter case, the sender shall be assigned an ID number and/or password from the server computer before accessing its ARS system through the telephone system.

In case that the telephone system is selected as the input means of all or part of the audio message, the sender accesses the automatic response system(ARS) of the server computer of the Provider through the telephone network and thus the server computer is initialized. The sender then inputs the ID number and/or password for obtaining approval of inputting the audio message. If everything is in order, the audio message may be inputted and confirmed. If the inputted ID number and/or the password is denied approval, the process may not be continued.

The inputted audio message will be packaged and compressed to be added to the previously inputted composite message information.

Then, the information such as the personal data of the sender and the recipient, the audio/visual message and so on inputted to the computer will be packaged, compressed and stored. The inputted information will be transmitted to the server computer of the Provider in due course.

FIG. 8 illustrates a flowchart of a process of downloading the composite message information through the output device from the server computer.

In FIG. 8 as the output device is connected to the server computer through the Internet and thus the server computer is initialized, the ID number or password is to be inputted; when the registration of the ID number or password is confirmed, the access is approved; when the output device requires the composite message information, the server computer transmits the required message data to the output device or the output device will have it downloaded. When the retrieval or downloading of the composite message information is completed, the operation of the server computer is finished and the process is completed.

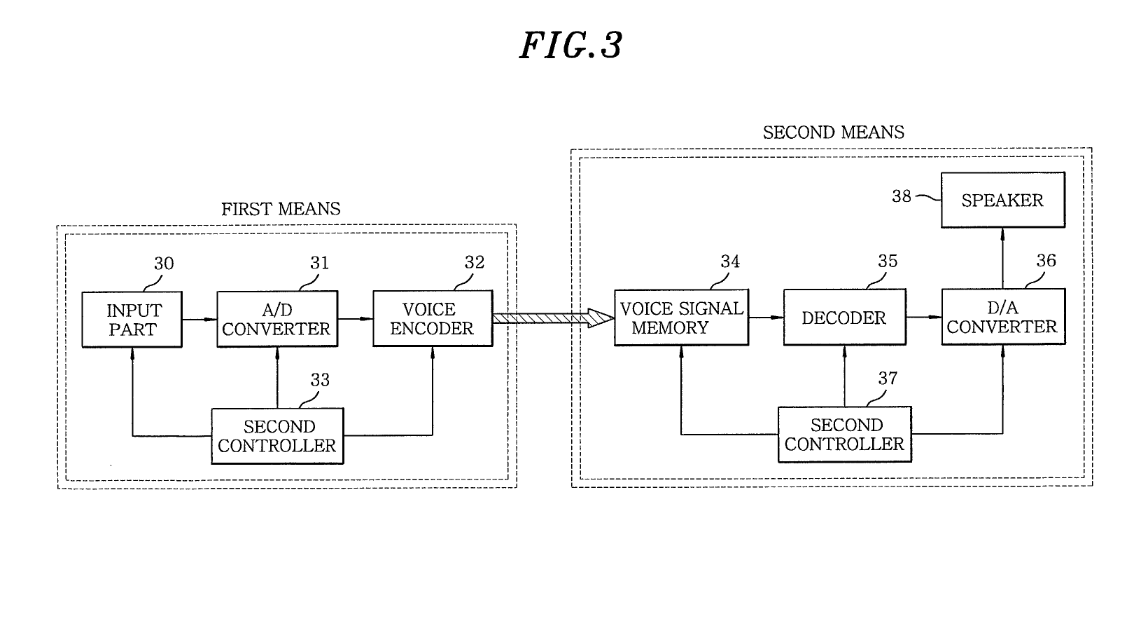

In accordance with the present invention, for inputting the audio information, for example, a sound card in the computer may be used and thus the Provider may not have to use an additional A/D converter for converting analog sound signals into digital sound signals. Accordingly, costs for operating the system of the invention can be curtailed in comparison with the prior art of FIG. 3. Also, the invention is more convenient than the prior art of FIG. 3, since the names and addresses and other literal information of the sender and the recipient are inputted directly through the keyboard and thus recording of such information and reproduction thereof for converting such information into letters or characters are not required. In addition, holographs or handwritings as well as images can be exchanged between the two parties. Also, contents and quality of the audio information delivered by the method and system according to this invention are superior in comparison with those of the prior art of FIG. 3.

According to the present invention, it is possible to send accurately and intimately the intentions, gratitude, wishes, etc. of the sender or the person requesting for delivery of a specific goods purchased by home shopping, electronic commerce, etc. to the recipient by sending a message card comprising audio information such as congratulatory music, greetings, etc., and visual information such as printed characters, holographs, pictures, etc.

Further, it is possible according to the invention to deliver good news and words of congratulations or consolations on various occasions such as, Christmas, birthdays, wedding anniversaries, 60th birthdays, New Years and so on.

Furthermore, with the present invention, a message card or goods such as toys to which a message card may be attached, inserted or installed can be delivered quickly at a low price even to a distant destination.

What is claimed is:

1. A method for sending audio-visual messages through a computer communication networks, comprising the steps of:
inputting and storing visual information such as the name and address of the sender and the recipient, etc. to/at a computer(or the like) as an input system;
transmitting signals corresponding to the visual information and audio information such as the voice of the user, etc. (hereafter referred to as composite message information) through a computer communication network and storing them at a computer as an output system; and
storing audio information signals among the composite message information signals from said output system and printing the visual information onto a message card respectively.

2. A method as claimed in claim 1, wherein one or more websites(or the like) are established on said computer communication system and a server computer of said website is accessible by said input system and output system through said computer communication network.

3. A method as claimed in claim 1 or 2, wherein the visual and audio information signals are stored together at said computer as the input device and transmitted to the output device through said computer communication network.

4. The method as claimed in claim 1 or 2, wherein only the visual information or all of visual information and part of the audio information are inputted to said computer as the input device, while all or part of the audio information is inputted through a telephone network accessible to said computer communication network.

5. A method as claimed in claim 1 or 2, wherein said visual information includes diagrams, holographs, pictures, etc. inputted and stored by using a device such as digital camera, scanner, or the like.

6. A method as claimed in claim 1 or 2, wherein the said computer communication network is the Internet.

7. A system for sending and receiving audio-visual messages through a computer communication network, comprising:
at least one or more computers 100 as an input device of said messages to which visual and audio information may be inputted and stored;
a computer communication network 200 to which said input devices 100 are connected for transmitting signals of said messages;
an output device 300 as a computer connected to said computer communication network 200 for receiving said signal; and
one or more message cards 400 as a receiving unit for printing the visual information of said messages and storing the audio information signals from the above output device 300 therein.

8. System as claimed in claim 7, wherein one or more websites having a server computer 210 is set up on said computer communication network.

9. System as claimed in claim 7, wherein one or more telephone networks 200A is accessible by one or more telephone networks 200A.

10. System as claimed in claim 8, wherein said server computer 210 is accessible by one or more telephone networks 200A

11. System as claimed in claim 7, 8 or 9, wherein said input device 100 is a personal computer comprising:
a microphone 101 for inputting audio information; an A/D converter 102 for converting the audio information received through said microphone 101 into digital signals;
an encoder 103 for encoding the digital audio information signals converted by said A/D converter;
a keyboard 104 for inputting the literal information such as the names and addresses of the user and the other party (a sender or recipient), a letter, etc,;
a packaging/compressing part 105 for combining and compressing the encoded digital audio and literal information signals;
a decoder 106 for verifying the encoded audio information signals;
a D/A converter 107;
a speaker 108;and a controller 109 for controlling operation of said parts.

12. System as claimed in claim 7, 8 or 9, wherein said input device 100 may be a PC, mobile phone, digital TV or PDA.

13. System as claimed in claim 7, 8 or 9, wherein said output device 300 is a personal computer comprising:
a hard disk 301 as a storage for the composite message signal data;
a de-packaging/decompressing part 302 for decompressing the compressed composite message signal data and separating the packaged data;
a printer 303 for printing out the literal information such as names and addresses, letters, etc. decoded from said de-packaging/decompressing part 302;
an interface 304 for outputting the encoded audio information from said de-packaging/decompressing part 302;and
a controller 305 for controlling the operation of said parts.

14. System as claimed in claim 7,8 or 9, wherein said message cards 400 are activated by said output device 300 under the control of a control part 401 therein thereby the visual information from said output device 300 being printed on a printing part 402 and the audio information being stored at a memory 403 by means of said interface 304.
